(19) United States
(12) Patent Application Publication
(10) Pub. No.: US 2005/0029276 A1
(43) Pub. Date: Feb. 10, 2005

(54) Condiment container

(76) Inventors: David B. Johnson, Alexandria, VA (US); Jeffrey A. Schmidt, Arlington, VA (US)

Correspondence Address: David B. Johnson, 576 N. St. Asaph St., Alexandria, VA, 22314, US

(21) Appl. No.: 10/634,982

(22) Filed: Aug. 6, 2003

(51) Int. Cl. A47J 29/00

(52) U.S. Cl. 220/912

(57) ABSTRACT

A container including a closure, wherein the closure has a tool disposed thereon. The tool may be a rod, a fork, a spoon, a spork, a knife, or any other suitable tool. The container may be used for dispensing condiments or contents other than condiment, and is particularly useful for dispensing viscous fluids.

### BACKGROUND

1. Field of the Invention

This invention relates to a tool that is disposed on an under-side of a closure to a container, particularly a condiment container. The tool facilitates dispensing of the condiment from the container in an easy motion. When a user removes the closure and opens the container, they would pull the tool out of the container as they lift the closure away from the container. The tool can then be used to assist in dispensing the condiment or other viscous liquid.

2. Related Art

There have been several patents directed to bottle cap-dispensing devices in the condiment dispensing art. None of these inventions are designed to help facilitate the dispensing of condiment from a ketchup and/or mustard container, wherein a tool is contained within the container itself.

### SUMMARY OF THE INVENTION

The concepts of the present invention will be discussed with respect to a ketchup bottle, but such is done for the sake of convenience and simplicity only. That is, the concepts of the present invention are equally applicable to all types of condiment receptacles, and are further applicable to any container that holds a viscous liquid.

It is often very difficult to dispense ketchup out of a glass or hard plastic bottle. Numerous attempts at hitting or tapping the bottom of the bottle, radically jerking the bottle down to move the ketchup is often embarrassing and is potentially messy.

According to the concepts of the present invention, there is a tool disposed on the closure—typically a screwable bottle cap, or lid—so that the tool extends down into the condiment receptacle. Accordingly, when the user removes the closure, they then have the tool already in hand, and the tool has already been extended into the bottle and, thus, has condiment already thereon. It is thus easy to employ the tool to coax as much of the condiment from the receptacle as is desired. Such a tool would be especially useful for condiments used in restaurants, as such typically come in glass bottles that cannot be squeezed, and are notorious for the problem of difficulty in removing the condiment. This difficulty may be particularly vexing for a user who is very hungry and is eager to get at the condiment so they can consume their food. Such an eager user may be a child who would otherwise annoy his parents no end until the condiment is dispensed from the container. Thus, embodiments consistent with the concepts of the present invention may promote family harmony at restaurants. Further, embodiments consistent with the concepts of the present invention would be especially useful for ketchup bottles because, due to the viscous nature of the ketchup and the design of the bottle, the ketchup is typically very difficult to pour from the bottle without effort. Tapping the bottom of the bottle or radically jerking it only to accidentally pour too much or create a mess is frustrating to any user. Embodiments consistent with the concepts of the present invention will eliminate that problem for a great number of people.

There is thus a diminished risk of accidentally spilling condiment while trying to dispense it through tapping or jerking the receptacle downward. Further, it is convenient to use and does not force one to use an eating utensil or some other device to accomplish the same mission. A condiment receptacle having a tool consistent with the concepts of the present invention will not cause the user to notice any difference in the weight of a condiment receptacle because the tool is light-weight. The tool is very easy to use and will not cause any embarrassment to the user. A user can thus easily get exactly the right amount of condiment as is desired.

### BRIEF DESCRIPTION OF THE DRAWINGS

The above and other objects and advantages of embodiments consistent with the concepts of the present invention will become more apparent by describing in detail embodiments consistent with the concepts and principles thereof with reference to the accompanying drawings, wherein like reference numerals designate like or corresponding parts throughout the several views, and wherein:

FIG. 1 is a plan view of a perspective view of a container-closure having a tool disposed thereon, according to a first embodiment;

FIG. 2 is an end view of the apparatus depicted in FIG. 1, wherein the view is taken from the free end of the tool looking back at the closure;

FIG. 3 is an end view similar to that shown in FIG. 2, but having the tool in an alternative position relative to the center of the closure;

FIG. 4 is a perspective view of a container-closure having a tool disposed thereon, according to a second embodiment;

FIG. 5 is a perspective view of a container-closure having a tool disposed thereon, according to a third embodiment;

FIG. 6 is an end view of the apparatus depicted in FIG. 5, wherein the view is taken from the free end of the tool looking back at the container-closure;

FIG. 7 is a perspective view of a container-closure having a tool disposed thereon, according to a fourth embodiment;

FIG. 8 is an end view of the apparatus depicted in FIG. 7, wherein the view is taken from the free end of the tool looking back at the container-closure;

FIG. 9 is a perspective view of a container-closure having a tool disposed thereon, according to a fifth embodiment; and

FIG. 10 is an perspective view of a container.

### DETAILED DESCRIPTION OF NON-LIMITING EXEMPLARY EMBODIMENTS CONSISTENT WITH THE CONCEPTS OF THE PRESENT INVENTION

Again, the concepts of the present invention will be discussed with respect to a ketchup bottle, but such is done for the sake of convenience and simplicity only. That is, the present invention is equally applicable to all types of condiment receptacles, and is further applicable to any container that holds a viscous liquid. Further, the condiment, or viscous liquid, is not particularly limited, but embodiments consistent with the concepts of the present invention will be particularly useful with condiments such as ketchup, mustard, relish, and salad dressing.

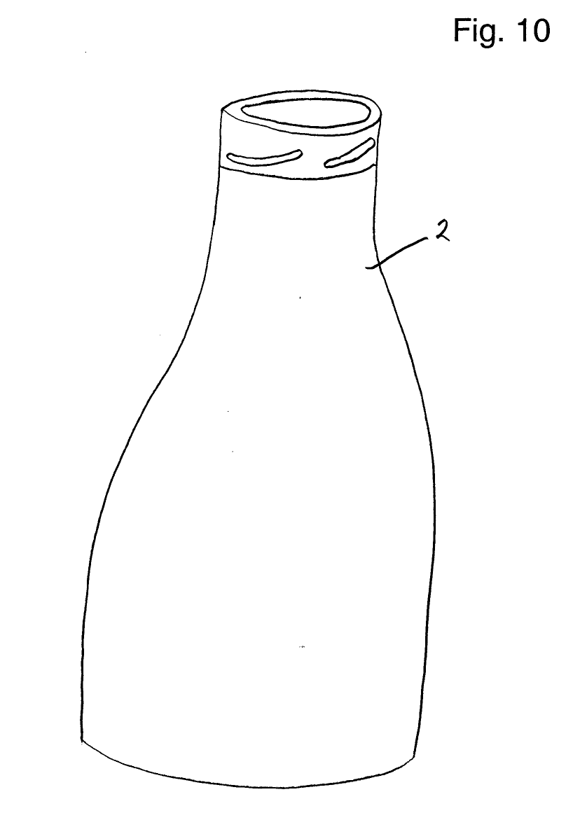

The invention can be embodied in a container having a closure. The container may be such as a jar, bottle, receptacle, and the like. An exemplary container 2 is shown in FIG. 10, but the shape and type thereof are not particularly limited. The closure may be one that screws, snaps, or is otherwise engaged with the container. The engagement of the closure to the container is not particularly limited. Various embodiments of closure are shown throughout the figures, and will be discussed in more detail below. That is, the particular container and its closure are not limited in type, shape, or engagement.

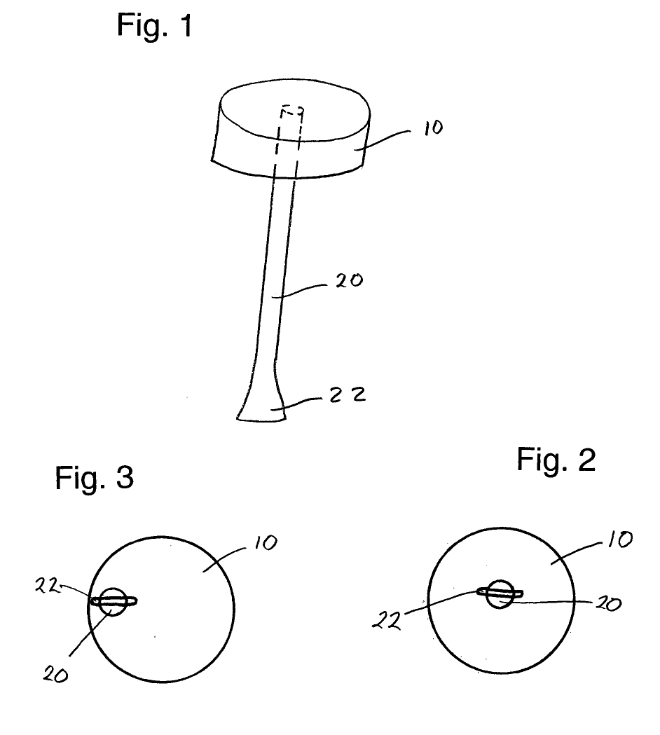

A first embodiment consistent with the concepts of the present invention is shown in FIGS. 1-3. In FIG. 1, there is shown a closure 10 having a tool 20 disposed thereon so as to extend in a manner that would place the tool 20 inside the container 2 when the closure 10 is engaged with the container 2. The tool 20 has a shaft which is shown as a rod with a flared end 22. The tool 20 may be disposed in the center of the closure 10 as shown in FIG. 2, or may be off-center as shown in FIG. 3. The embodiment of FIG. 3 is particularly useful in scraping the viscous fluid from the sides of the container 2 as the closure 10 is placed thereon, when the closure is of the screw-on type. Although shown with a flared end 22, the tool 20 need not have such a feature. Instead, the tool 20 may be a simple rod along its entire length. The length of the tool is not particularly limited, but may be dimensioned so as to extend near the bottom of the container 2 when the closure 10 is secured thereto.

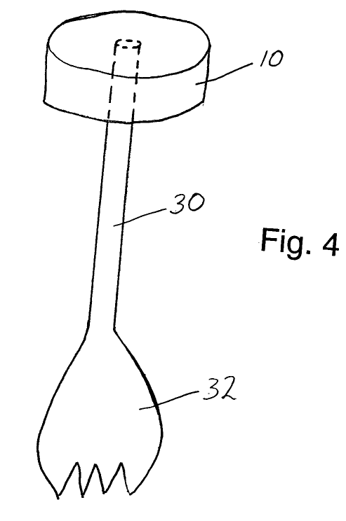

FIG. 4 shows a second embodiment. In FIG. 4 shows a closure 10 having a tool 30 disposed thereon. The tool 30 has a working end 32 that is commonly known as a “spork”, which is the combination of a spoon and a fork. Although a spork is shown, the tool 30 may include only a spoon, or only a fork. This embodiment is particularly useful for containers that hold salad dressing. Advantageously, when a user of the container having salad dressing removes the closure 10 from the container, they may then use the spoon to scoop the salad dressing onto their salad. This would be particularly useful for picnics where utensils may not be readily available, and with salad dressing that is particularly viscous such as Ranch or Blue Cheese. Further, the container holding the salad dressing may be sized so as to hold only one serving, and that container may be packaged with a ready-made salad, thereby offering convenience to the user. In such a single-serving size, the tool may then also be used to consume the salad or other food to which the salad dressing is applied. Such an arrangement would make a nice convenience lunch package, which would be healthy for the user.

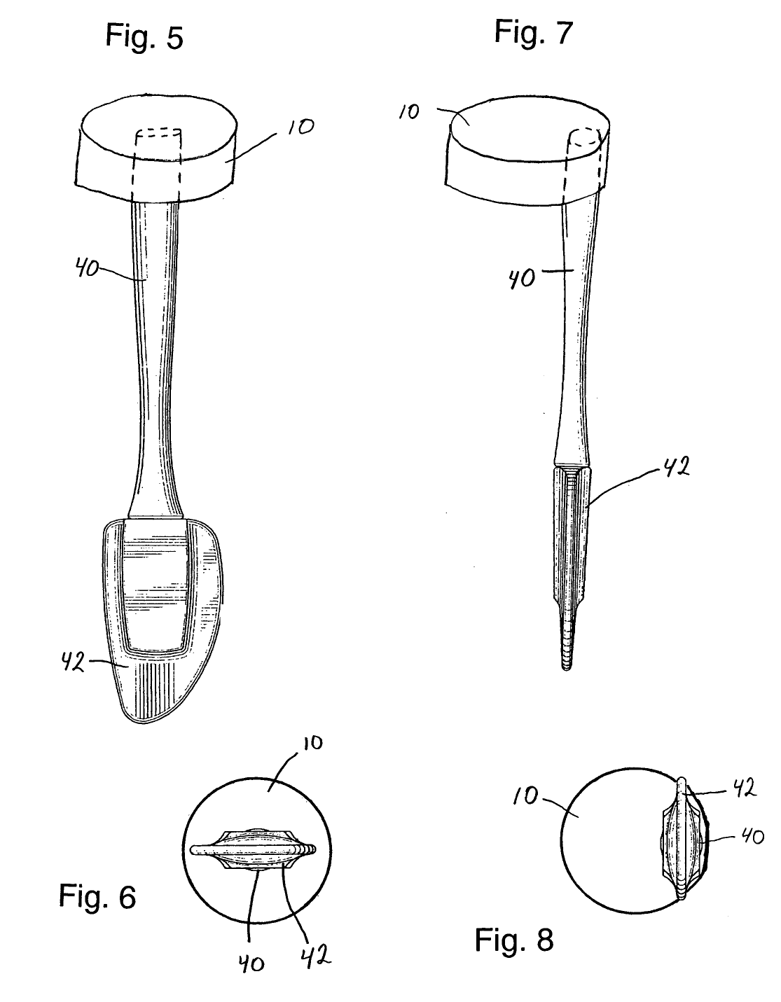

FIGS. 5-8 show a third embodiment. In FIG. 5, there is shown a closure 10 having a tool 40 that is in the form of a spatula having a scraper 42 as its working end. As shown in FIG. 6, the tool 40 may be disposed so as to be centered on the closure 10. Alternatively, for example, the tool 40 may be disposed off-center so as to engage with the side-wall of the container when the closure 10 is engaged therewith. This embodiment is particularly useful for the value-conscious user, who can use the spatula to obtain the maximum amount of contents from the container as the contents decrease to almost none.

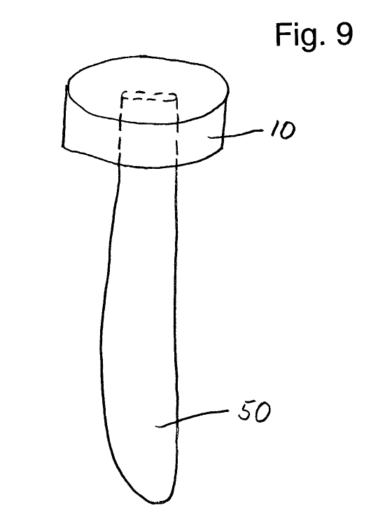

FIG. 9 shows a fourth embodiment. In FIG. 9, there is shown a closure 10 having a knife 50 attached thereto as the tool.

It is contemplated that numerous modifications may be made to the extender-arm of the present invention without departing from the spirit and scope of the invention as defined in the following claims.

For example, although specific types of tools are shown, there may be other tools useful to the user of a container with a closure and, therefore, the concepts of the present invention may be applied thereto. Further, although the tool is shown as extending—over its entire length—perpendicular to a portion of the closure adapted to close an opening in a container, such need not be the case. Instead, the tool may extend in a perpendicular manner over some of its length, and then bend to one side or another. Such an arrangement would be particularly useful when the bend in the tool is matched to the bend in the wall of the container to which the closure will be engaged.

This idea is the first of its kind that addresses the problem of a person not being able to easily dispense ketchup, mustard, or other condiment, from a bottle. Embodiments consistent with the concepts of this invention could ultimately have application with any type of container where there is a desire to pour viscous liquid that does not pour easily. Overall, there is provided a convenient, lightweight, easy to use device to solve this problem who everyone who encounters it.

1. A condiment dispenser comprising:
a container having condiment disposed therein;
a closure removably engaged with said container, wherein said closure comprises a tool disposed thereon so that the tool extends into the container when the closure is engaged with said container.

2. A condiment dispenser as set forth in to claim 1, wherein said tool is a rod.

3. A condiment dispenser as set forth in to claim 1, wherein said tool is a fork.

4. A condiment dispenser as set forth in to claim 1, wherein said condiment is salad dressing.

5. A condiment dispenser as set forth in to claim 1, wherein said tool is a spoon.

6. A condiment dispenser as set forth in to claim 1, wherein said tool is a spork.

7. A condiment dispenser as set forth in to claim 1, wherein said tool is a spatula.

8. A condiment dispenser as set forth in to claim 1, wherein said tool is a knife.

9. A condiment dispenser as set forth in to claim 1, wherein said condiment is ketchup.

10. A container-closure comprising:
a closure body adapted to engage a container; and
a tool disposed on said closure body, wherein said tool is disposed on said closure body so that when said closure body is engaged with the container, said tool extends into the container, and further wherein said tool does not include a brush or an eye-dropper.

11. A container-closure as set forth in claim 10, wherein said tool is a fork.

12. A container-closure as set forth in claim 10, wherein said tool is a spoon.

13. A container-closure as set forth in claim 10, wherein said tool is a spork.

14. A container-closure as set forth in claim 10, wherein said tool is a knife.

15. A container-closure as set forth in claim 10, wherein said tool is disposed so as to be perpendicular to a surface of said closure body that is adapted to close an opening in a container.

16. A container-closure as set forth in claim 10, in combination with a container.

17. A container-closure and container as set forth in claim 16, further comprising condiment disposed in said container.
